(19) United States
(12) Patent Application Publication
(10) Pub. No.: US 2023/0107217 A1
(43) Pub. Date: Apr. 6, 2023

(54) GAME CONTROL DEVICE

(71) Applicant: Chicony Electronics Co., Ltd., New Taipei City (TW)

(72) Inventor: Huai-Chih Chen, New Taipei City (TW)

(21) Appl. No.: 17/880,173

(22) Filed: Aug. 3, 2022

(30) Foreign Application Priority Data
Oct. 1, 2021 (TW) 110136797

(51) Int. Cl. A63F 13/24; H01R 12/71; H01R 12/70

(52) U.S. Cl. CPC A63F 13/24; H01R 12/71; H01R 12/7082; H01R 12/7076; H01R 12/7047; H01R 12/716; H01R 13/2471

(57) ABSTRACT

A game control device includes a housing, a circuit board, a joystick control module, and a limiting frame. The housing includes a shell plate, a through hole, and an internal accommodation space. The through hole is defined through the shell plate along an axial direction and in communication with the internal accommodation space. The circuit board is disposed in the internal accommodation space. The joystick control module includes a joystick and a motion sensor. The motion sensor is disposed in the internal accommodation space and electrically connected to the circuit board. One end of the joystick is detachably connected to the motion sensor, the other end of the joystick protrudes out of the shell plate, and the joystick is within the through hole. The limiting frame is disposed on the shell plate and detachably connected to the through hole to limit a movement of the joystick along the axial direction.

### CROSS-REFERENCE TO RELATED APPLICATION

This non-provisional application claims priority under 35 U.S.C. § 119(a) to Patent Application No. 110136797 filed in Taiwan, R.O.C. on Oct. 1, 2021, the entire contents of which are hereby incorporated by reference.

### BACKGROUND

### Technical Field

The instant disclosure relates to a control device, in particular, to a game control device.

### Related Art

The game control device is a device for a user for inputting signals into a game upon playing the game. For example, the user may perform motions such as moving, jumping, or direction control in the game through the joystick of the game control device.

### SUMMARY

In general, a game control device known to the inventor includes a housing and a joystick. The housing has a through hole, one of two ends of the joystick is installed inside the housing, and the other end of the joystick protrudes out of the through hole for being operated by a user. However, during the operation of the game control device, the joystick may be damaged or worn upon being used for a long time. Moreover, if foreign matters such as dust or debris enter the housing, the operation of the joystick will be affected. For example, when foreign matters or debris generated by the abrasion between the joystick and the housing enter the through hole, the foreign matters or debris easily cause the joystick fail to operate or malfunction after the operation.

Furthermore, upon addressing such issue, the user mostly takes the game control device to a repair store for repairment or buys a new game control device, thus leading the inconvenience of the user and increasing the burden of the user. Moreover, if the user tries to disassemble the device for repairment by himself or herself, the process is time-consuming. Furthermore, when the repairment of the device by the user is failed, the game control device will be damaged or have malfunctions easily.

In view of this, in one embodiment, a game control device is provided. The game control device comprises a housing, a circuit board, a joystick control module, and a limiting frame. The housing comprises a shell plate, a through hole, and an internal accommodation space. The shell plate has an outer surface. The through hole is defined through the shell plate along an axial direction so as to be in communication with the internal accommodation space. The circuit board is disposed in the internal accommodation space. The joystick control module comprises a joystick and a motion sensor. The motion sensor is disposed in the internal accommodation space and electrically connected to the circuit board. One of two ends of the joystick is detachably connected to the motion sensor, the other end of the joystick passes through the through hole and protrudes out of the outer surface, and the joystick is within the through hole. The limiting frame is disposed on the outer surface and detachably connected to a peripheral portion of the through hole, and the limiting frame limits a movement of the joystick along the axial direction.

Based on the above, in the game control device according to one or some embodiments of the instant disclosure, the limiting frame is disposed on the outer surface and detachably connected to the peripheral portion of the through hole, and the joystick is detachably connected to the motion sensor and is within the through hole. Therefore, when the joystick is damaged or worn, or when foreign matters at the joystick are to be removed, or when the user tends to change the appearance or style of the joystick, the user can detach the limiting frame from the shell plate and then take the joystick out of the through hole for performing replacement, cleaning, repairment, or styling of the joystick. Hence, the user does not need to disassemble the housing of the game control device. Accordingly, not only the user can use and operate the game control device conveniently and the usage cost of the game control device can be reduced, but also the user can easily change of the appearance or the style of the joystick according to different requirements.

### BRIEF DESCRIPTION OF THE DRAWINGS

The disclosure will become more fully understood from the detailed description given herein below for illustration only, and thus not limitative of the disclosure, wherein:

FIG. 1 illustrates a perspective view of a game control device according to an exemplary embodiment of the instant disclosure;

FIG. 2 illustrates an exploded view of the game control device of the exemplary embodiment;

FIG. 3 illustrates a partial sectional view of the game control device of the exemplary embodiment;

FIG. 4 illustrates a cross-sectional view showing the limiting frame of the game control device is at a fixed position;

FIG. 5 illustrates a cross-sectional view showing the limiting frame of the game control device is at a released position;

FIG. 6 illustrates a partial exploded view of the game control device of the exemplary embodiment;

FIG. 7 illustrates a top view of the game control device of the exemplary embodiment; and

FIG. 8 illustrates a partial exploded view of a game control device according to another exemplary embodiment of the instant disclosure.

### DETAILED DESCRIPTION

Embodiments are provided for facilitating the descriptions of the instant disclosure. However, the embodiments are provided as examples for illustrative purpose, but not a limitation to the instant disclosure. Moreover, in the figures, some components are not shown for clearly showing the technical features according to one or some embodiments of the instant disclosure. In all the figures, the same reference numbers refer to identical or similar elements.

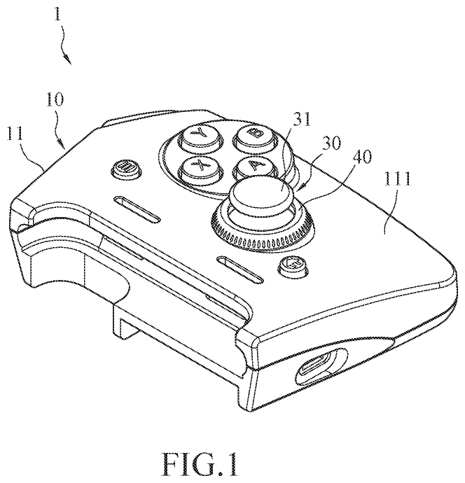

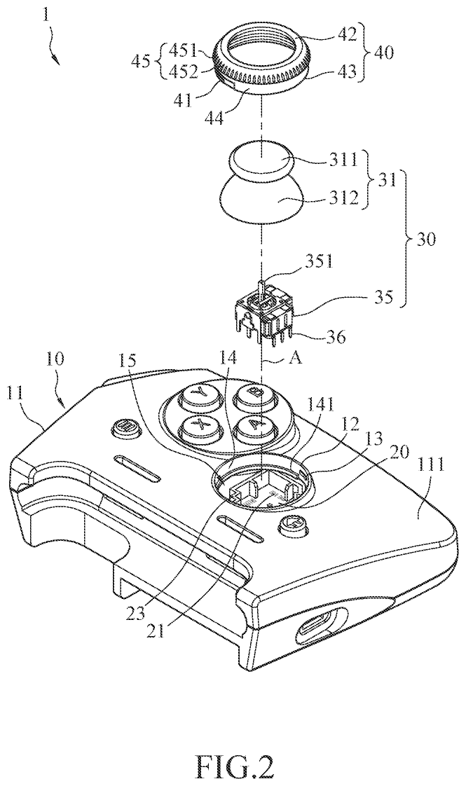

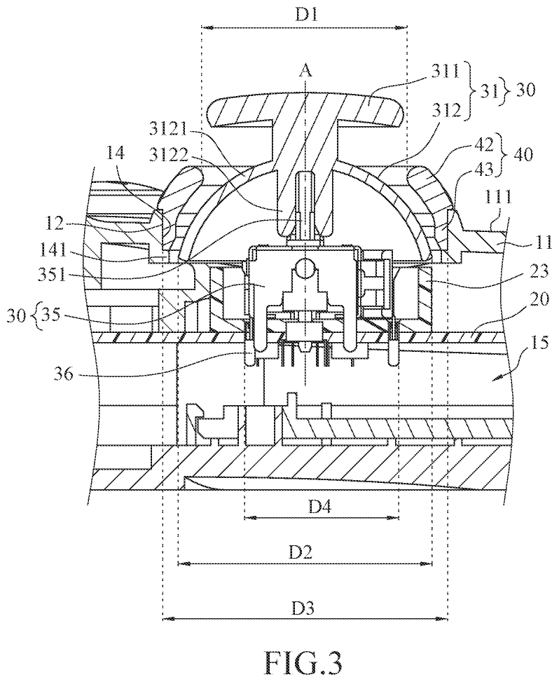

FIG. 1 illustrates a perspective view of a game control device 1 according to an exemplary embodiment of the instant disclosure. FIG. 2 illustrates an exploded view of the game control device 1 of the exemplary embodiment. FIG. 3 illustrates a partial sectional view of the game control device 1 of the exemplary embodiment. As shown in FIG. 1 to FIG. 3, the game control device 1 comprises a housing 10, a circuit board 20, a joystick control module 30, and a limiting frame 40. In some embodiments, the game control device 1 may be a game controller for various electronic apparatuses upon executing the games. For example, the electronic apparatus may be a home game console, a handheld game console, a computer, a smart phone, or the like. Moreover, the game control device 1 may be a wired game controller or a wireless game controller.

As shown in FIG. 1 to FIG. 3, the housing 10 comprises a shell plate 11, a through hole 12, and an internal accommodation space 15. The shell plate 11 has an outer surface 111, the through hole 12 is defined through the shell plate 11 along an axial direction A so as to be in communication with the internal accommodation space 15, and the circuit board 20 is disposed in the internal accommodation space 15. In this embodiment, the through hole 12 is a round hole, but may be a hole with other shapes (such as elliptical, square, rectangular, or irregular).

As shown in FIG. 1 to FIG. 3, the joystick control module 30 comprises a joystick 31 and a motion sensor 35. The joystick 31 may be a three-axis joystick so as to provide operation directions over 360 degrees, or the joystick 31 may be a one-axis joystick so as to provide two operation directions (such as up and down or left and right) or may be a two-axis joystick so as to provide four operation directions (such as up and down as well as left and right). The motion sensor 35 is disposed in the internal accommodation space 15 for sensing the motion(s) of the joystick 31 so as to generate corresponding signal(s). Moreover, the motion sensor 35 is electrically connected to the circuit board, so that the circuit board can receive the signal(s) sensed by the motion sensor 20 for signal processing and output, thus allowing the joystick 31 to perform motions such as moving, jumping, or direction control in the game.

As shown in FIG. 1 to FIG. 3, one of two ends of the joystick 31 is in the internal accommodation space 15 of the housing 10 and is detachably connected to the motion sensor 35, and the other end of the joystick 31 passes through the through hole 12 of the housing 10 and protrudes out of the outer surface 111 for being operable by the user. For example, the user can rotate or press the joystick 31.

As shown in FIG. 1 to FIG. 3, in this embodiment, the motion sensor 35 has a shaft 351. The joystick 31 comprises a head portion 311 and a base portion 312, the base portion 312 is in the internal accommodation space 15 of the housing 10, and the base portion 312 has a shield body 3121 and a connection portion 3122. The shield body 3121 is semi-spherical shaped, and the connection portion 3122 is in the shield body 3121. In this embodiment, the connection portion 3122 is a rod extending from a bottom portion of the head portion 311 toward the motion sensor 35, but the instant disclosure is not limited thereto. The shield body 3121 covers the motion sensor 35. The shaft 351 of the motion sensor 35 is inserted into the connection portion 3122. The shaft 351 and the connection portion 3122 may be connected to each other through a clearance fit manner, an interference fit manner, or a transition fit manner, so that, the joystick 31 is in a detachable condition that the joystick 31 can be detached from motion sensor 35 upon being forced. The head portion 311 of the joystick 31 extends from the base portion 312, passes through the through hole 12 of the housing 10, and protrudes out of the outer surface 111 for being operable by the user. In some embodiments, the head portion 311 and the base portion 312 of the joystick 31 are integrally formed as a one-piece member or are assembled with each other, but the instant disclosure is not limited thereto.

As shown in FIG. 1 to FIG. 3, the limiting frame 40 is an independent component, and the limiting frame 40 is disposed on the outer surface 111 and is detachably connected to a peripheral portion of the through hole 12. For example, the limiting frame 40 may be connected to the peripheral portion of the through hole 12 by engaging, threading, fitting (such as the clearance fitting, the interference fitting, or the transition fitting), or the like, so that the limiting frame 40 is in a detachable condition that the limiting frame 40 can be detached from the housing 10 upon being forced. The head portion 311 of the joystick 31 further protrudes out of the limiting frame 40 for being operable by the user. The limiting frame 40 is configured to limit the movement of the joystick 31 along the axial direction A. In other words, in this embodiment, because the joystick 31 is in the detachable condition that the joystick 31 can be detached from the motion sensor 35 upon being forced, the axial movement of the joystick 31 can be limited by the limiting frame 40. Therefore, during the operation of the joystick 31, the joystick 31 can be prevented from being moved along the axial direction A and thus not to be detached from the motion sensor 35 or detached from the through hole 12 of the housing 10. For example, as shown in FIG. 3, a minimum width D1 of one end of the limiting frame 40 away from the through hole 12 may be less than a maximum width D2 of the base portion 312 of the joystick 31. For instance, the minimum width D1 of the end of the limiting frame 40 away from the through hole 12 may be 2 centimeters (cm), and the maximum width D2 of the base portion 312 of the joystick 31 may be 2.2 cm, 2.3 cm, or 2.5 cm, so that the limiting frame 40 can provide a limiting function to the joystick 31 so as to limit the movement of the joystick 31 along the axial direction A.

In some embodiments, the limiting frame 40 may be a ring-shaped structure, and a shape of the limiting frame 40 corresponds to the shape of the through hole 12. Moreover, the limiting frame 40 may be made of plastic material(s) with higher mechanical strength and higher rigidity such as polycarbonate (PC) or polyoxymethylene (POM), so that the limiting frame 40 is more wear-resistant during operation of the game control device 1.

Moreover, as shown in FIG. 1 to FIG. 3, the joystick 31 is within the through hole 12. Therefore, after the limiting frame 40 is detached from the housing 10, the joystick 31 can be taken out of the through hole 12 directly. Taking the embodiment shown in FIG. 3 as an example, in the case that the through hole 12 is a round hole, the maximum width D2 of the joystick 31 may be 2.2 cm, 2.3 cm, or 2.5 cm, and the diameter D3 of the through hole 12 may be 2.7 cm, 2.8 cm, or 3 cm and thus greater than the maximum width D2 of the joystick 31. Therefore, the joystick 31 is within the through hole 12. In another embodiment, supposed that the through hole 12 is a square hole, the maximum width D2 of the joystick 31 may be 2.2 cm, 2.3 cm, or 2.5 cm, the side length of the through hole 12 may be 2.7 cm, 2.8 cm, or 3 cm and thus greater than the maximum width D2 of the joystick 31. Therefore, the joystick 31 is within the through hole 12.

Furthermore, the limiting frame 40 is an independent component and disposed on the outer surface 111 of the housing 10 instead of the inside of the housing 10. Therefore, according to one or some embodiments, when the joystick 31 is worn or damaged, or when the foreign matters at the joystick 31 are to be removed, or when the appearance or style of the joystick 31 is to be changed, the user can detach the limiting frame 40 from the housing 10 barehanded or with the hand tool(s) without disassembling the housing 10. In addition, the joystick 31 is detachably connected to the motion sensor 35 and is within the through hole 12. Therefore, after the limiting frame 40 is detached from the housing 10, the user can take the joystick 31 out of the through hole 12 for performing such as replacement, cleaning, repairment, or styling of the joystick 31, and the user does not need to disassemble the housing 10 of the game control device 1. Accordingly, in this embodiment, not only the user can use and operate the game control device 1 conveniently and the usage cost of the game control device 1 can be reduced, but also the user can easily change the appearance or the style of the joystick 31 according to different requirements. Furthermore, in this embodiment, because the user does not need to disassemble the housing 10, the assembling or detachment of the joystick 31 is not failed easily and thus the internal circuits of the game control device 1 are not damaged.

Furthermore, specifically, in this embodiment, when the joystick 31 is worn or damaged, after the user takes the joystick 31 out of the through hole 12, a new joystick 31 can be placed in the through hole 12 and connected to the motion sensor 35, and the limiting frame 40 can be assembled on the peripheral portion of the through hole 12. Hence, the user can replace or repair the game control device 1 by himself or herself, and thus the usage cost of the game control device 1 can be reduced. Moreover, the user can replace the joystick 31 with a new joystick 31 having a different shape, a different color, or a different material. Therefore, the appearance or style of the game control device 1 can be changed freely to provide unique visual effects and feelings. Moreover, when dust or debris are at the position of the joystick 31 or the motion sensor 35 and the operation of the game control device 1 is thus affected, the user can detach the joystick 31 from the through hole 12 without disassembling the housing 10 to clean the game control device 1 by himself or herself and does not need to take the game control device 1 to a repair store. Therefore, the user can use and operate the game control device 1 conveniently and the usage cost of the game control device 1 can be reduced.

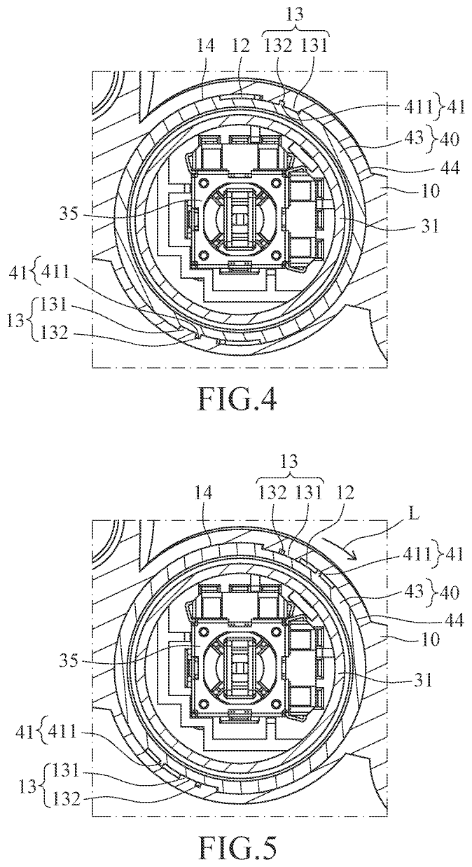

FIG. 4 illustrates a cross-sectional view showing the limiting frame 40 of the game control device 1 is at a fixed position. FIG. 5 illustrates a cross-sectional view showing the limiting frame 40 of the game control device 1 is at a released position. As shown in FIG. 3 to FIG. 5, the limiting frame 40 can be detached from or assembled on the housing 10 in a rotating manner. For example, in this embodiment, the peripheral portion of the through hole 12 is provided with a first assembling portion 13, the limiting frame 40 is provided with a second assembling portion 41, and the limiting frame 40 is capable of selectively rotated to a fixed position or a released position with respect to the through hole 12. When the limiting frame 40 is at the fixed position (as shown in FIG. 4), the first assembling portion 13 and the second assembling portion 41 are assembled with each other, so that the limiting frame 40 can be fixed with the housing 10 and thus the joystick 31 can be prevented from being detached from the through hole 12. When the limiting frame 40 is rotated to the released position (as shown in FIG. 5), the first assembling portion 13 and the second assembling portion 41 can be detached from each other, so that the limiting frame 40 is not fixed and can be detached from the through hole 12 of the housing 10.

For example, as shown in FIG. 4 and FIG. 5, the through hole 12 of the housing 10 has an inner surrounding surface 14, and the first assembling portion 13 is disposed on the inner surrounding surface 14. In this embodiment, the first assembling portion 13 comprises two protruding blocks 131, the two protruding blocks 131 are disposed on two opposite sides of the inner surrounding surface 14, and each of the protruding blocks 131 has an engaging groove 132. As shown in FIG. 2, the limiting frame 40 comprises an outer annular body 42 and an inner annular body 43, the inner annular body 43 is in the through hole 12 and has a peripheral surface 44, and the second assembling portion 41 is disposed on the peripheral surface 44. In this embodiment, the second assembling portion 41 comprises two engaging blocks 411 to correspond to the two engaging slots 132, respectively. When the limiting frame 40 is rotated to the fixed position (the position shown in FIG. 4), the two engaging blocks 411 are respectively engaged with the two engaging slots 132, so that the limiting frame 40 can be fixed with the housing 10. When the limiting frame 40 is forced so as to be rotated from the fixed position to the released position (the position shown in FIG. 5) (rotated along the arrow L shown in FIG. 5), the two engaging blocks 411 can be detached from the two engaging slots 132, so that the limiting frame 40 can be released and thus can be detached from the through hole 12 of the housing 10.

As shown in FIG. 1 to FIG. 3, in this embodiment, the outer annular body 42 of the limiting frame 40 is out of the through hole 12 and leans against the outer surface 111 of the shell plate 11. One end of the inner surrounding surface 14 of the through hole 12 of the housing 10 adjacent to the circuit board 20 is provided with an annular flange 141, and the inner annular body 43 of the limiting frame 40 further leans against the annular flange 141. Therefore, during the process of assembling the limiting frame 40 with the through hole 12, the inner annular body 43 of the limiting frame 40 can be placed into the through hole 12 in advance, so that the inner annular body 43 leans against the annular flange 141 and the outer annular body 42 leans against the outer surface 111 of the shell plate 11. Therefore, before the limiting frame 40 is fixed with the housing 10, the limiting frame 40 can be limited and positioned in advance, so that it is convenient for the user to subsequently operate the limiting frame 40 to be rotated.

As shown in FIG. 2, in this embodiment, a surface of the limiting frame 40 is further provided with a non-slip structure 45. For example, the non-slip structure 45 may be a recessed structure (e.g., a recessed groove or a recessed pattern) or a protruding structure (e.g., a protruding block, a protruding spot, or a protruding pattern). Therefore, the user can operate the limiting frame 40 conveniently. In this embodiment, the non-slip structure 45 comprises a plurality of recessed portions 451 and a plurality of protruding portions 452, and the recessed portions 451 and the protruding portions 452 are alternately and annularly arranged on the peripheral surface of the outer annular body 42 of the limiting frame 40. That is, in this embodiment, each of the protruding portions 452 is formed between adjacent recessed portions 451. Therefore, when the user operates the limiting frame 40 to be rotated, the non-slip structure 45 increases the contact friction force, so that the user can operate the limiting frame 40 with less efforts. In some embodiments, the non-slip structure 45 may only comprise the recessed portion 451 or may only comprise the protruding portion 452, and the number of the recessed portion 451 or the protruding portion 452 is not limited.

As shown in FIG. 1 to FIG. 3, in this embodiment, the motion sensor 35 is also detachably and electrically connected to the circuit board 20, and the motion sensor 35 is within the through hole 12. Therefore, after the limiting frame 40 is detached from the housing 10, the motion sensor 35 can be taken out of the through hole 12 directly. Taking the embodiment shown in FIG. 3 as an example, in the case that the through hole 12 is a round hole, the diameter D3 of the through hole 12 may be 2.7 cm, 2.8 cm, or 3 cm, and a maximum width D4 of the motion sensor 35 may be 1 cm, 1.5 cm, or 2 cm and thus less than the diameter D3 of the through hole 12. Therefore, the motion sensor 35 is within the through hole 12. In another embodiment, supposed that the through hole 12 is a rectangular hole, the length and the width of the through hole 12 may be respectively greater than the length and the width of the motion sensor 35. Therefore, the motion sensor 35 is within the through hole 12.

Therefore, according to one or some embodiments, when the motion sensor 35 is worn or damaged or when the foreign matters at the motion sensor 35 are to be removed, the user can also take the motion sensor 35 out of the through hole 12 for performing such as replacement, cleaning, or repairment of the motion sensor 35 without disassembling the housing 10. For example, the user can detach the limiting frame 40 from the housing 10 and take out the joystick 31 from the through hole 12. Then, the user can insert a hand tool into the housing 10 through the through hole 12 so as to detach the motion sensor 35 from the circuit board 20 and take out the motion sensor 35 from the through hole 12. The following various electrical connection methods could be used between the motion sensor 35 and the circuit board 20.

As shown in FIG. 1 and FIG. 2, the circuit board 20 may be provided with an electrical receptacle connector 21, the motion sensor 35 may be provided with an electrical plug connector 36, and the electrical plug connector 36 of the motion sensor 35 is connected to electrical receptacle connector 21 of the circuit board 20. Therefore, the motion sensor 35 is electrically connected to the circuit board 20, and the electrical plug connector 36 is in a detachable condition that the electrical plug connector 36 can be detached from the electrical receptacle connector 21 upon being forced.

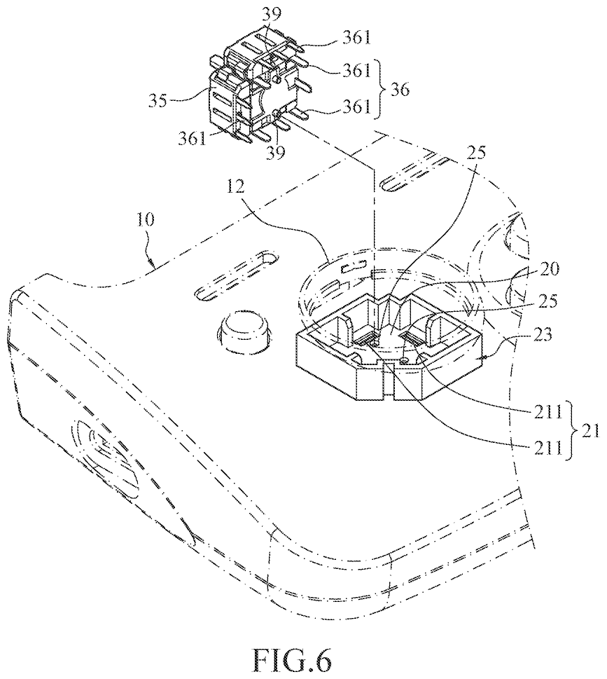

FIG. 6 illustrates a partial exploded view of the game control device 1 of the exemplary embodiment. As shown in FIG. 6, in this embodiment, the electrical plug connector 36 of the motion sensor 35 comprises a plurality of conductive terminals 361, and the conductive terminals 361 are annularly disposed on a peripheral portion of the motion sensor 35 and extend toward the circuit board 20. The electrical receptacle connector 21 of the circuit board 20 comprises a plurality of conductive slots 211, and the number of the conductive slots 211 may correspond to the number of the conductive terminals 361. The conductive terminals 361 may be inserted into the conductive slots 211, respectively, so that the motion sensor 35 is electrically connected to the circuit board 20. After the conductive terminals 361 are inserted into the conductive slots 211, the motion sensor 35 still can be moved toward the through hole 12 of the housing 10 upon being forced, so that the conductive terminals 361 can be detached from the conductive slots 211 so as to detach the motion sensor 35 from the circuit board 20. Moreover, the conductive terminals 361 are annularly disposed on the peripheral portion of the motion sensor 35. Therefore, after the motion sensor 35 is assembled with the circuit board 20, the motion sensor 35 can be fixed with the circuit board 20 more stably and without being wobbled easily, and a poor contact between the motion sensor 35 and the circuit board 20 can be prevented.

Furthermore, as shown in FIG. 6, in this embodiment, the circuit board 20 is further provided with at least one limiting hole 25 (in this embodiment, two limiting holes 25), and the motion sensor 35 is provided with at least one limiting post 39 (in this embodiment, two limiting posts 39). The limiting post 39 of the motion sensor 35 is correspondingly inserted into the limiting hole 25 of the circuit board 20, so that the movement of the motion sensor 35 can be limited. Moreover, in this embodiment, because the circuit board 20 is provided with a plurality of limiting holes 25 and the motion sensor 35 is provided with a plurality of limiting posts 39, the user can determine the assembling direction of the motion sensor 35 quickly and correctly, thereby allowing the assembling efficiency of the motion sensor 35 to be increased.

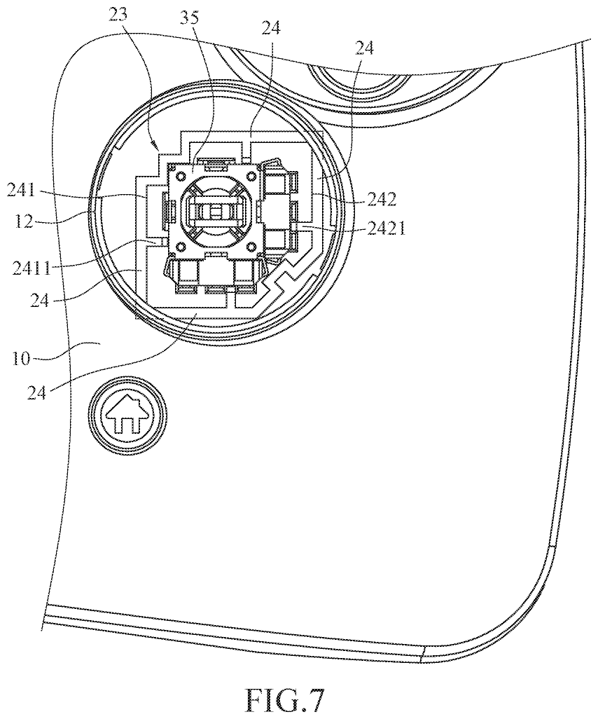

FIG. 7 illustrates a top view of the game control device 1 of the exemplary embodiment. As shown in FIG. 6 and FIG. 7, in this embodiment, the circuit board 20 is further provided with a mating receptacle 23, and the motion sensor 35 is disposed in the mating receptacle 23. Therefore, after the motion sensor 35 is assembled with the circuit board 20, the motion sensor 35 can be limited by the mating receptacle 23 without being wobbled easily. Moreover, the user can identify the assembling direction of the motion sensor 35 more easily.

As shown in FIG. 7, the mating receptacle 23 may comprise at least two stopping walls 24. In this embodiment, the mating receptacle 23 comprises a plurality of stopping walls 24, the stopping walls 24 are connected with each other to form a tubular structure, and the motion sensor 35 is disposed among the stopping walls 24. However, the foregoing embodiment is just for illustrative purposes. In some embodiments, the mating receptacle 23 may only comprise two stopping walls 24 at opposite sides; or, in some embodiments, the mating receptacle 23 comprises a plurality of stopping walls 24, and the stopping walls 24 are not connected with each other.

Furthermore, as shown in FIG. 6 and FIG. 7, in this embodiment, the mating receptacle 23 has a first inner surface 241 and a second inner surface 242 facing the first inner surface 241. The first inner surface 241 is provided with a first protruding post 2411, the second inner surface 242 is provided with a second protruding post 2421, and the motion sensor 35 is between an end portion of the first protruding post 2411 and an end portion of the second protruding post 2412. Therefore, the movement of the motion sensor 35 can be limited, and the motion sensor 35 is spaced from the first inner surface 241 and spaced from the second inner surface 242. Hence, the user can insert a hand tool into the gap between the first inner surface 241 and the motion sensor 35 and the gap between the second inner surface 242 and the motion sensor 35, so that the user can apply a force to detach the motion sensor 35 from the circuit board 20 easily. In some embodiments, each of the inner surfaces of the mating receptacle 23 is provided with a corresponding protruding post, and the motion sensor 35 is among the protruding posts so that the movement of the motion sensor 35 can be limited.

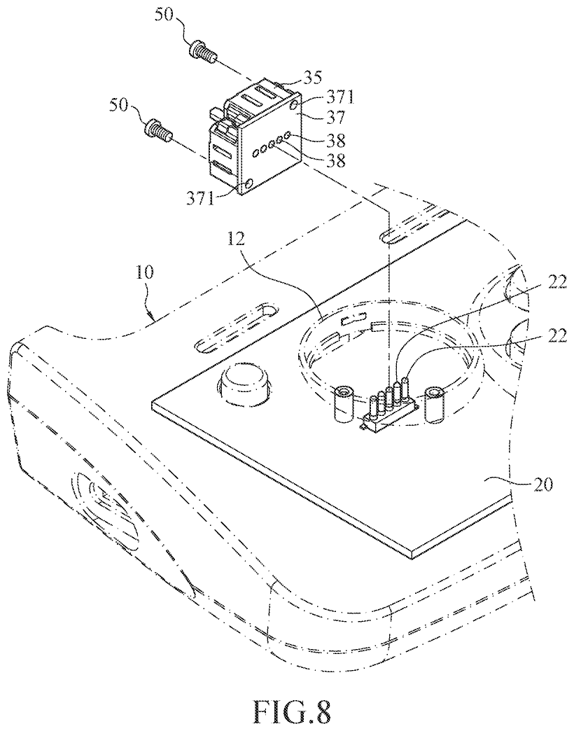

FIG. 8 illustrates a partial exploded view of a game control device according to another exemplary embodiment of the instant disclosure. The difference between the embodiment shown in FIG. 8 and the embodiment shown in FIG. 6 is at least the connection between the motion sensor 35 and the circuit board 20. As shown in FIG. 8, in this embodiment, the circuit board 20 is provided with at least one first conductive member 22 (in this embodiment, a plurality of first conductive members 22 is arranged into a row), and each of the first conductive members 22 is a pogo pin connector. The motion sensor 35 has an adapter plate 37, the adapter plate 37 is provided with at least one second conductive member 38 (in this embodiment, a plurality of second conductive members 38 is arranged into a row), and each of the second conductive members 38 is a metal conductive contact. The adapter plate 37 is detachably assembled on the circuit board 20 through a fixation member 50 (in this embodiment, the number of the fixation member 50 is two). In this embodiment, the fixation member 50 is a screw to lock the adapter plate 37 on the circuit board 20. Therefore, the first conductive members 22 of the circuit board 20 and the second conductive members 38 of the motion sensor 35 are in contact with each other to achieve the electrical connection between the circuit board 20 and the motion sensor 35. Moreover, the fixation member 50 is removable so that the motion sensor 35 can be detached from the circuit board 20. In some embodiments, both the first conductive member 22 and the second conductive member 38 may be metal conductive contacts; alternatively, in some embodiments, the first conductive member 22 is a metal conductive contact and the second conductive member 38 is a pogo pin connector, but the instant disclosure is not limited thereto.

Furthermore, as shown in FIG. 8, in this embodiment, an installing portion 371 (in this embodiment, a hole) of the adapter plate 37 of the motion sensor 35 for assembling the fixation member 50 may be within the through hole 12 of the housing 10, so that the user can perform the assembling and disassembling of joystick control module conveniently. For example, after the user detaches the limiting frame 40 from the housing 10 and takes the joystick 31 out of the through hole 12, the user can insert the hand tool into the housing 10 through the through hole 12 to remove the fixation member 50, and then the user can detach the motion sensor 35 from the circuit board 20 and take the motion sensor 53 out of the through hole 12.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A game control device comprising:
a housing comprising a shell plate, a through hole, and an internal accommodation space, wherein the shell plate has an outer surface, and the through hole is defined through the shell plate along an axial direction so as to be in communication with the internal accommodation space;
a circuit board disposed in the internal accommodation space;
a joystick control module comprising a joystick and a motion sensor, wherein the motion sensor is disposed in the internal accommodation space and electrically connected to the circuit board; one of two ends of the joystick is detachably connected to the motion sensor, the other end of the joystick passes through the through hole and protrudes out of the outer surface, and the joystick is within the through hole; and
a limiting frame disposed on the outer surface and detachably connected to a peripheral portion of the through hole, wherein the limiting frame limits a movement of the joystick along the axial direction.

2. The game control device according to claim 1, wherein the peripheral portion of the through hole is provided with a first assembling portion, the limiting frame is provided with a second assembling portion, and the limiting frame is capable of selectively rotated to a fixed position or a released position with respect to the through hole; when the limiting frame is at the fixed position, the first assembling portion and the second assembling portion are assembled with each other; when the limiting frame is at the released position, the first assembling portion and the second assembling portion are detached from each other.

3. The game control device according to claim 2, wherein the through hole has an inner surrounding surface, and the first assembling portion is disposed on the inner surrounding surface; the limiting frame comprises an outer annular body and an inner annular body, the inner annular body is in the through hole and has a peripheral surface, the second assembling portion is disposed on the peripheral surface, and the outer annular body is out of the through hole and leans against the outer surface of the shell plate.

4. The game control device according to claim 3, wherein one end of the inner surrounding surface adjacent to the circuit board is provided with an annular flange, and the inner annular body further leans against the annular flange.

5. The game control device according to claim 1, wherein a surface of the limiting frame is further provided with a non-slip structure.

6. The game control device according to claim 5, wherein the non-slip structure comprises at least one selected from the group consisting of at least one recessed portion and at least one protruding portion.

7. The game control device according to claim 1, wherein the motion sensor is detachably and electrically connected to the circuit board, and the motion sensor is within the through hole.

8. The game control device according to claim 7, wherein the circuit board is provided with an electrical receptacle connector, the motion sensor is provided with an electrical plug connector, and the electrical plug connector is detachably connected to the electrical receptacle connector.

9. The game control device according to claim 8, wherein the electrical plug connector comprises a plurality of conductive terminals, and the conductive terminals are annularly disposed on a peripheral portion of the motion sensor, the electrical receptacle connector comprises a plurality of conductive slots, and each of the conductive terminals is detachably inserted into a corresponding one of the conductive slots.

10. The game control device according to claim 7, wherein the circuit board is provided with a first conductive member, the motion sensor is provided with a second conductive member, the motion sensor is detachably assembled on the circuit board through a fixation member, so that the first conductive member and the second conductive member are in contact with each other.

11. The game control device according to claim 10, wherein the first conductive member or the second conductive member is a pogo pin connector.

12. The game control device according to claim 1, wherein the circuit board is provided with a mating receptacle, and the motion sensor is disposed in the mating receptacle.

13. The game control device according to claim 12, wherein the mating receptacle has a first inner surface and a second inner surface facing the first inner surface, the first inner surface is provided a first protruding post, the second inner surface is provided with a second protruding post, and the motion sensor is between an end portion of the first protruding post and an end portion of the second protruding post, so that the motion sensor is spaced from the first inner surface and spaced from the second inner surface.

14. The game control device according to claim 1, wherein the circuit board has a limiting hole, and the motion sensor is provided with a limiting post, so that the limiting post is correspondingly inserted into the limiting hole.

15. The game control device according to claim 1, wherein the joystick comprises a head portion and a base portion, the base portion is detachably connected to the motion sensor, the head portion extends from the base portion, passes through the through hole and the limiting frame, and protrudes out of the outer surface, a minimum width of one end of the limiting frame away from the through hole is less than a maximum width of the base portion, so that the movement of the joystick along the axial direction is limited.
